(19) United States
(12) Patent Application Publication
(10) Pub. No.: US 2007/0011012 A1
(43) Pub. Date: Jan. 11, 2007

(54) Method, system, and apparatus for facilitating captioning of multi-media content

(76) Inventors: Steve Yurick, South Park, PA (US); Michael Knight, Pittsburgh, PA (US); Jonathan Scott, Pittsburgh, PA (US); Rimas Buinevicius, Madison, WI (US); Monty Schmidt, Madison, WI (US)

Correspondence Address: FOLEY & LARDNER LLP, 150 EAST GILMAN STREET, P.O. BOX 1497, MADISON, WI, 53701-1497, US

(21) Appl. No.: 11/178,858

(22) Filed: Jul. 11, 2005

(51) Int. Cl. G10L 11/00

(52) U.S. Cl. 704/277

(57) ABSTRACT

A method, system and apparatus for facilitating transcription and captioning of multi-media content are presented. The method, system, and apparatus include automatic multi-media analysis operations that produce information which is presented to an operator as suggestions for spoken words, spoken word timing, caption segmentation, caption playback timing, caption mark-up such as non-spoken cues or speaker identification, caption formatting, and caption placement. Spoken word suggestions are primarily created through an automatic speech recognition operation, but may be enhanced by leveraging other elements of the multi-media content, such as correlated text and imagery by using text extracted with an optical character recognition operation. Also included is an operator interface that allows the operator to efficiently correct any of the aforementioned suggestions. In the case of word suggestions, in addition to best hypothesis word choices being presented to the operator, alternate word choices are presented for quick selection via the operator interface. Ongoing operator corrections can be leveraged to improve the remaining suggestions. Additionally, an automatic multi-media playback control capability further assists the operator during the correction process.

### FIELD OF THE INVENTION

The present invention relates generally to the field of captioning and more specifically to a system, method, and apparatus for facilitating efficient, low cost captioning services to allow entities to comply with accessibility laws and effectively search through stored content.

### BACKGROUND OF THE INVENTION

In the current era of computers and the Internet, new technologies are being developed and used at an astonishing rate. For instance, instead of conducting business via personal contact meetings and phone calls, businessmen and women now utilize video teleconferences. Instead of in-class lectures, students are now able to obtain an education via distance learning courses and video lectures over the Internet. Instead of giving numerous presentations, corporations and product developers now use video presentations to market ideas to multiple groups of people without requiring anyone to leave their home office. As a result of this surge of new technology, industries, schools, corporations, etc. find themselves with vast repositories of accumulated, unsearchable multi-media content. Locating relevant content in these repositories is costly, difficult, and time consuming. Another result of the technological surge is new rules and regulations to ensure that all individuals have equal access to and benefit equally from the information being provided. In particular, Sections 504 and 508 of the Rehabilitation Act, the Americans with Disabilities Act (ADA), and the Telecommunications Act of 1996 have set higher standards for closed captioning and equal information access.

In 1998, Section 508 of the Rehabilitation Act (Section 508) was amended and expanded. Effective Jun. 21, 2001, Section 508 now requires federal departments and agencies to ensure that federal employees and members of the public with disabilities have access to and use of information comparable to that of employees and members of the public without disabilities. Section 508 applies to all federal agencies and departments that develop, procure, maintain, or use electronic and information technology. On its face, Section 508 only applies to federal agencies and departments. However, in reality, Section 508 is quite broad. It also applies to contractors providing products or services to federal agencies and departments. Further, many academic institutions, either of their own accord or as required by their state board of education, may be required to comply with Section 508.

Academic and other institutions are also affected by the ADA and Section 504 of the Rehabilitation Act (Section 504). The ADA and Section 504 prohibit postsecondary institutions from discriminating against individuals with disabilities. The Office for Civil Rights in the U.S. Department of Education has indicated through complaint resolution agreements and other documents that institutions covered by the ADA and Section 504 that use the Internet for communication regarding their programs, goods, or services, must make that information accessible to disabled individuals. For example, if a university website is inaccessible to a visually impaired student, the university is still required under federal law to effectively communicate the information on the website to the student. If the website is available twenty-four hours a day, seven days a week for other users, the information must be available that way for the visually impaired student. Similarly, if a university website is used for accessing video lectures, the lectures must also be available in a way that accommodates hearing impaired individuals. Failure to comply can result in costly lawsuits, fines, and public disfavor.

Academic institutions can also be required to provide auxiliary aids and services necessary to afford disabled individuals with an equal opportunity to participate in the institution's programs. Auxiliary aids and services are those that ensure effective communication. The Title II ADA regulations list such things as qualified interpreters, Brailled materials, assistive listening devices, and videotext displays as examples of auxiliary aids and services.

Another area significantly affected by new rules and regulations regarding equal access to information is the broadcasting industry. In its regulations pursuant to the Telecommunications Act of 1996, the Federal Communications Commission (FCC) sets forth mandates for significant increases in closed captioning by media providers. The FCC regulations state that by Jan. 1, 2006, 100% of programming distributors' new, non-exempt video programming must be provided with captions. Further, as of Jan. 1, 2008, 75% of programming distributors' pre-rule non-exempt video programming being distributed and exhibited on each channel during each calendar quarter must be provided with closed captioning.

Accessibility to information can also refer to the ability to search through and locate relevant information. Many industries, professions, schools, colleges, etc. are switching from traditional forms of communication and presentation to video conferencing, video lectures, video presentations, and distance learning. As a result, massive amounts of multi-media content are being stored and accumulated in databases and repositories. There is currently no efficient way to search through the accumulated content to locate relevant information. This is not only burdensome for individuals with disabilities, but to any member of the population in need of relevant content stored in such a database or repository.

Current multi-media search and locate methods, such as titling or abstracting the media, are limited by their brevity and lack of detail. Certainly a student searching for information regarding semiconductors is inclined to access the lecture entitled ‘semiconductors’ as a starting point. But if the student needs to access important exam information that was given by the professor as an afterthought in one of sixteen video lectures, current methods offer no starting point for the student.

Transcription, which is a subset of captioning, is a service extensively utilized in the legal, medical, and other professions. In general, transcription refers to the process of converting speech into formatted text. Traditional methods of transcription are burdensome, time consuming, and not nearly efficient enough to allow media providers, academic institutions, and other professions to comply with government regulations in a cost effective manner. In traditional deferred (not live) transcription, a transcriptionist listens to an audio recording and types until he/she falls behind. The transcriptionist then manually stops the audio recording, catches up, and resumes. This process is very time consuming and even trained transcriptionists can take up to 9 hours to complete a transcription for a 1 hour audio segment. In addition, creating timestamps and formatting the transcript can take an additional 6 hours to complete. This can become very costly considering that trained transcriptionists charge anywhere from sixty to two hundred dollars or more per hour for their services. With traditional live transcription, transcripts are generally of low quality because there is no time to correct mistakes or properly format the text.

Captioning enables multi-media content to be understood when the audio portion of the multi-media cannot be heard. Captioning has been traditionally associated with broadcast television (analog) and videotape, but more recently captioning is being applied to digital television (HDTV), DVDs (usually referred to subtitling), web-delivered multi-media, and video games. Offline captioning, the captioning of existing multi-media content, can involve several steps, including: basic transcript generation, transcript augmentation and formatting (caption text style/font/background/color, labels for speaker identification, non-verbal cues such as laughter, whispering or music, markers for speaker or story change, etc.), caption segmentation (determining how much text will show up on the screen at a time), caption synchronization with the video which defines when each caption will appear, caption placement (caption positioning to give clues as to who is speaking or to simply not cover an important part of the imagery), and publishing, encoding or associating the resulting caption information to the original multi-media content. Thus, preparing captions is very labor intensive, and may take a person 15 hours or more to complete for a single hour of multi-media content.

In recent years, captioning efficiency has been somewhat improved by the use of speech recognition techniques. Speech (or voice) recognition is the ability of a computer to recognize general, naturally flowing utterances from a wide variety of speakers. In essence, it converts audio to text by breaking down utterances into phonemes and comparing them to known phonemes to arrive at a hypothesis for the uttered word. Current speech recognition programs have very limited accuracy, resulting in poor first pass captions and the need for significant editing by a second pass operator. Further, traditional methods of captioning do not optimally combine technologies such as speech recognition, optical character recognition (OCR), and specific speech modules to obtain an optimal machine generated caption. In video lectures and video presentations, where there is written text accompanying a speaker's words, OCR can be used to improve the first pass caption obtained and allow terms not specifically mentioned by the speaker to be searched for. Further, specific speech modules can be used to enhance the speech recognition by supplementing it with field-specific terms and expressions not found in common speech recognition engines.

Current captioning systems are also inefficient with respect to corrections made by human operators. Existing systems usually display only speech recognition best-hypothesis results and do not provide operators with alternate word choices that can be obtained from word lattice output or similar output data of a speech recognizer. A word lattice is a word graph of all possible candidate words recognized during the decoding of an utterance, including other attributes such as their timestamps and likelihood scores. Similarly, an N-best list, which can be derived from a word lattice, is a list of the N most probable word sequences for a given utterance. Furthermore, word suggestions (hypothesis or alternate words) selected/accepted by the operator, are not leveraged to improve remaining word suggestions. Similarly, manual corrections made by an operator do not filter down through the rest of the caption, requiring operators to make duplicative corrections. Additionally, existing systems do not use speech recognition timing information and knowledge of the user's current editing point (cursor position) to enable automatically paced media playback during editing.

Thus, there is a need for a captioning system, method, and apparatus which can overcome the limitations of speech recognition and create a better first pass, machine generated caption by utilizing other technologies such as optical character recognition and specialized speech recognition modules. Further, there is a need for a captioning method which automatically formats a caption and creates and updates timestamps associated with words. Further, there is a need for a captioning method which lessens the costs of captioning services by simplifying the captioning process such that any individual can perform it. Further yet, there is a need for an enhanced caption editing method which utilizes filter down corrections, filter down alternate word choices, and a simplified operator interface.

There is also need for an improved captioning system that makes multi-media content searchable and readily accessible to all members of the population in accordance with Section 504, Section 508, and the ADA. Further, there is a need for a search method which utilizes indexing and contextualization to help provide individuals access to relevant information.

### SUMMARY OF THE INVENTION

An exemplary embodiment relates to a method for creating captions of multi-media content. The method includes performing an audio analysis operation on an audio signal to produce speech recognition data for each detected utterance, displaying the speech recognition data using an operator interface as spoken word suggestions for review by an operator, and enabling the operator to edit the spoken word suggestions within the operator interface. The speech recognition data includes a plurality of best hypothesis words, word lattices, and corresponding timing information. The enabling operation includes estimating an appropriate audio portion to be played to the operator at a current moment, based on an indication obtained from the operator interface as to where the operator is currently editing.

Another exemplary embodiment relates to a method for facilitating captioning. The method includes performing an automatic captioning function on multi-media content to create a machine caption by utilizing speech recognition and optical character recognition on the multi-media content. The method also includes providing a caption editor that includes an operator interface for facilitating an edit of the machine caption by a human operator and distributes the edit throughout the machine caption. The method further includes indexing a recognized word to create a searchable caption that can be searched with a multi-media search tool, where the multi-media search tool includes a search interface that allows a user to locate relevant content within the multi-media content.

### BRIEF DESCRIPTION OF THE DRAWINGS

FIG. 1 is an overview diagram of a system facilitating enhanced captioning of multi-media content.

FIG. 2 is a flow diagram illustrating exemplary operations performed in an automatic captioning engine.

FIG. 3 is a flow diagram illustrating exemplary operations performed during a multi-media analysis.

FIG. 4 is a flow diagram illustrating exemplary operations performed in a caption editor.

FIG. 5 is an exemplary operator interface which illustrates an alternate word feature of the caption editor described with reference to FIG. 4.

FIG. 6 is an exemplary operator interface which illustrates an incremental word suggestion feature of the caption editor described with reference to FIG. 4.

FIG. 7 is an exemplary settings screen for the operator interface described with reference to FIGS. 5 and 6.

FIG. 8 is a flow diagram illustrating exemplary operations performed in a multi-media indexing engine.

### DETAILED DESCRIPTION OF EXEMPLARY EMBODIMENTS

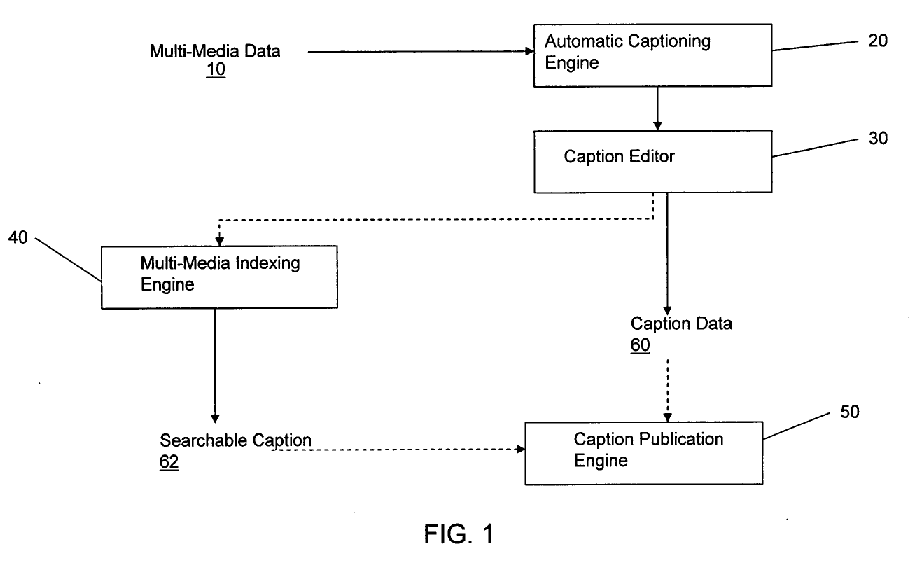

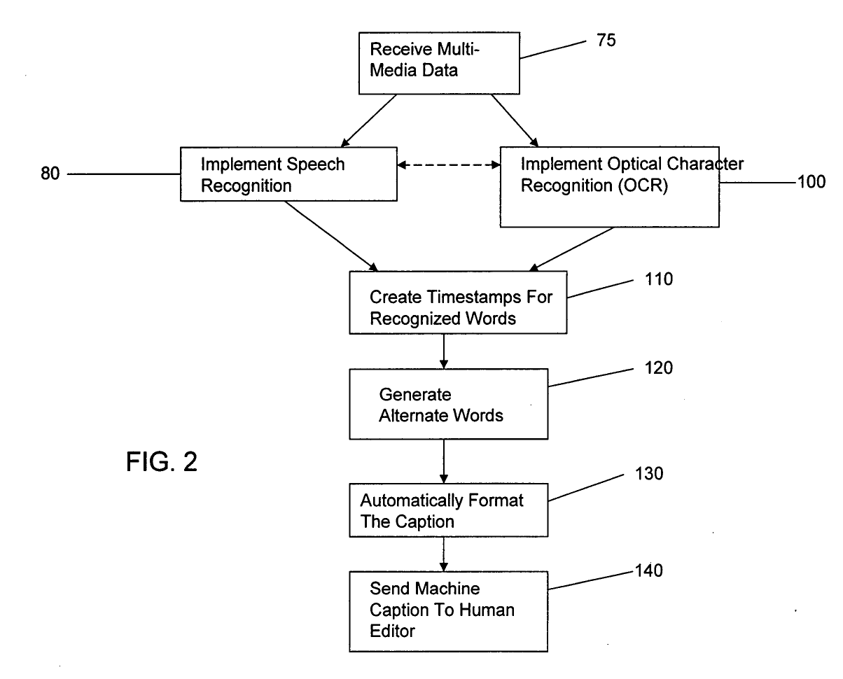

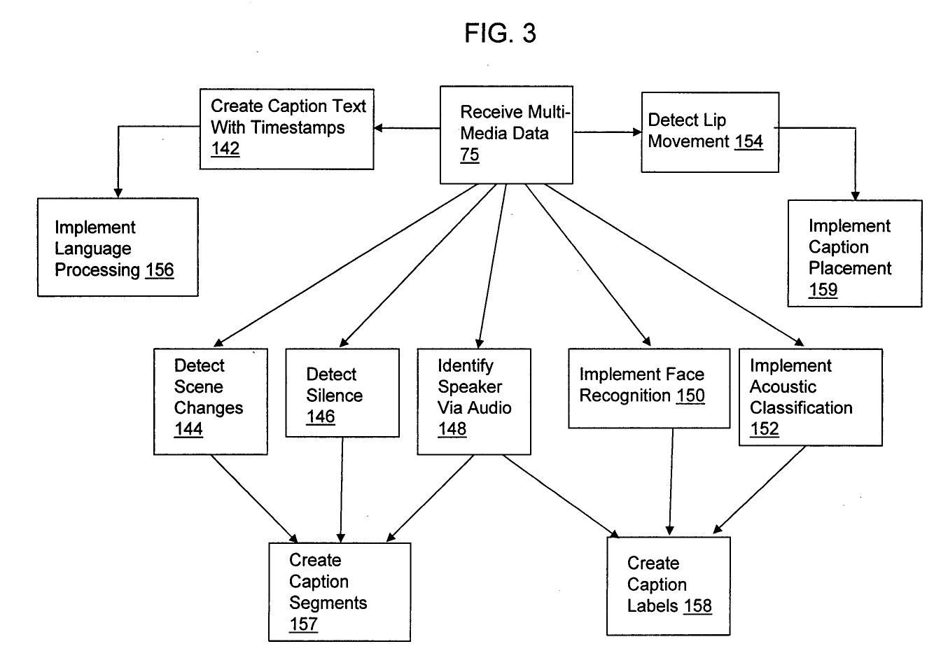

FIG. 1 illustrates an overview of an enhanced multi-media captioning system. An automatic captioning engine 20 can create a machine caption based on a multi-media data 10 input. The multi-media data 10 can be audio data, video data, or any combination thereof. The multi-media data 10 can also include still image data, multi-media/graphical file formats (e.g. Microsoft PowerPoint files, Macromedia Flash), and “correlated” text information (e.g. text extracted from a textbook related to the subject matter of a particular lecture). The automatic captioning engine 20 can use multiple technologies to ensure that the machine caption is optimal. These technologies include, but are not limited to, general speech recognition, field-specific speech recognition, speaker-specific speech recognition, timestamping algorithms, and optical character recognition. In one embodiment, the automatic captioning engine 20 can also create metadata for use in making captions searchable. In an alternative embodiment (shown with a dashed arrow), a multi-media indexing engine 40 can be used independent of, or in conjunction with the automatic captioning engine 20 to create a searchable caption 62. A multi-media search tool can allow users to search for relevant portions of multi-media content. In an alternative embodiment, an automatic multi-media analysis may be performed for the tasks of both making multi-media searchable and creating captions. Operations in a multi-media analysis, which are described in more detail with reference to FIG. 3, can include scene change detection, silence detection, face detection/recognition, speaker recognition via audio analysis, acoustic classification, object detection/recognition and the like. The automatic captioning engine 20 is described in more detail with reference to FIG. 2.

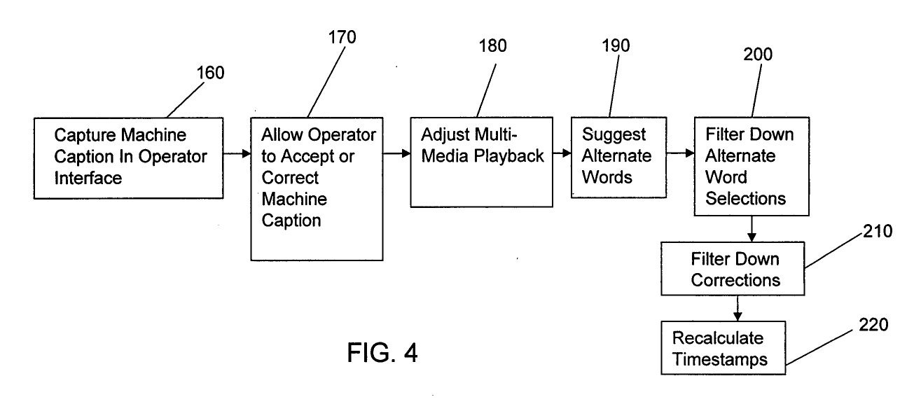

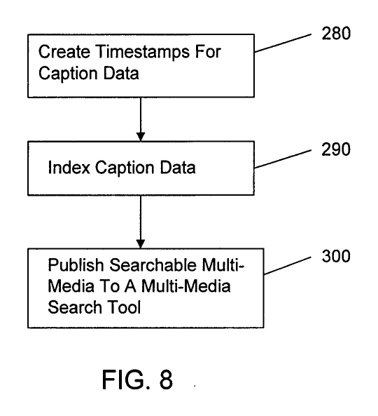

A caption editor 30 can be used by a human operator to edit a machine caption created by the automatic captioning engine 20. The caption editor 30 can include an operator interface with media playback functionality to facilitate efficient editing. The resulting caption data 60 may or may not be searchable, depending on the embodiment. In one embodiment, the caption editor 30 automatically creates a searchable caption as the machine caption is being edited. In an alternative embodiment (shown with a dashed arrow), the multi-media indexing engine 40 can create a searchable caption 62 based on an edited caption from the caption editor 30. The multi-media indexing engine 40 can be incorporated into either or both of the automatic caption engine 20 and caption editor 30, or it can be implemented in an independent operation. The caption editor 30 and multi-media indexing engine 40 are described in more detail with reference to FIGS. 4 and 8, respectively.

A caption publication engine 50 can be used to publish caption data 60 or a searchable caption 62 to an appropriate entity, such as television stations, radio stations, video producers, educational institutions, corporations, law firms, medical entities, search providers, a website, a database, etc. Caption output format possibilities for digital media players can include, but are not limited to, the SAMI file format to be used to display captions for video played back in Microsoft's Windows Media Player, the RealText or SMIL file format to be used to display captions in Real Network's RealPlayer, the QTtext format for use with the QuickTime media player, and the SCC file format for use within DVD authoring packages to produce subtitles. Caption publication for analog video can be implemented by encoding the caption data into Line 21 of the vertical blanking interval of the video signal.

FIG. 2 illustrates exemplary operations performed in the automatic captioning engine described with reference to FIG. 1. In an operation 75, multi-media data is received by the automatic captioning engine. The multi-media data can be sent directly from an entity desiring transcription/captioning services, downloaded from a website, obtained from a storage medium, obtained from live feed, directly recorded, etc. Once received, speech recognition can be performed on the multi-media data in an operation 80.

In general, speech recognition is a technology that allows human speech to automatically be converted into text. In one implementation, speech recognition works by breaking down utterances into phonemes which are compared to known phonemes to arrive at a hypothesis for each uttered word. Speech recognition engines can also calculate a ‘probability of correctness,’ which is the probability that a given recognized word is the actual word spoken. For each phoneme or word that the speech recognition engine tries to recognize within an utterance, the engine can produce both an acoustic score (that represents how well it matches the acoustic model for that phoneme or word) and a language model score (which uses word context and frequency information to find probable word choices and sequences). The acoustic score and language model score can be combined to produce an overall score for the best hypothesis words as well as alternative words within the given utterance. In one embodiment, the ‘probability of correctness’ can be used as a threshold for making word replacements in subsequent operations.

While speech recognition is ideal for use in creating captions, it is limited by its low accuracy. To improve on general speech recognition results, field-specific speech recognition can be incorporated into the speech recognition engine. Field-specific speech recognition strengthens ordinary speech recognition engines by enabling them to recognize more words in a given field or about a given topic. For instance, if a speaker in the medical field is giving a presentation to his/her colleagues regarding drugs approved by the Food and Drug Administration (FDA), a medically-oriented speech recognition engine can be trained to accurately recognize terms such as amphotericin, sulfamethoxazole, trimethoprim, clarithromycin, ganciclovir, daunorubicin-liposomal, doxorubicin hydrochloride-liposomal, etc. These and other field-specific terms would not likely be accurately recognized by traditional speech recognition algorithms.

In an alternative embodiment, speaker-specific speech recognition can also be used to enhance traditional speech recognition algorithms. Speaker-specific speech recognition engines are trained to recognize the voice of a particular speaker and produce accurate captions for that speaker. This can be especially helpful for creating captions based on speech from individuals with strong accents, with speech impediments, or who speak often. Similar to general speech recognition, field-specific and speaker-specific speech recognition algorithms can also create a probability of correctness for recognized words.

In an operation 100, optical character recognition (OCR) can be performed on received multi-media data. OCR is a technology that deciphers and extracts textual characters from graphics and image files, allowing the graphic or visual data to be converted into fully searchable text. Used in conjunction with speech recognition, OCR can significantly increase the accuracy of a machine-generated caption that is based on text-containing video. Using timestamps, probabilistic thresholds, and word comparisons, optically recognized words can replace speech recognized words or vice versa. In one embodiment, a “serial” processing approach can be used in which the results of one processing provides input into the other process. For example, text produced from OCR can be used to provide hints to a speech recognition process. One such implementation is using the OCR text to slant the speech recognition system's language model toward the selection of words contained in the OCR text. With this implementation, any timing information known about the OCR text (e.g. the start time and duration a particular PowerPoint slide or other image was shown during a presentation) can be used to apply the customized language model to that timeframe. Alternatively, speech recognition results can provide hints to the OCR engine. This approach is depicted in FIG. 2 by a dashed arrow between the OCR block (operation 100) to the speech recognition block (operation 80).

In an operation 110, timestamps can be created for both speech recognized words and optically recognized words and characters. A timestamp is a temporal indicator that links recognized words to the multi-media data. For instance, if at 30.25 seconds into a sitcom one of the characters says ‘hello,’ then the word ‘hello’ receives a timestamp of 00:00:30.25. Similarly, if exactly 7 minutes into a video lecture the professor displays a slide containing the word ‘endothermic,’ the word ‘endothermic’ receives a timestamp of 00:07:00.00. In an alternative embodiment, the word ‘endothermic’ can receive a timestamp duration indicating the entire time that it was displayed during the lecture. Timestamps can be created by the speech recognition and OCR engines. In the OCR case where the input is only an image, higher level information obtained from the multi-media data is available and can be utilized to automatically determine timestamps and durations. For example, in recorded presentations, script events embedded in a Windows Media video stream or file can be used to trigger image changes during playback. Therefore, the timing of these script events can provide the required information for timestamp assignment of the OCR text. In the example, all OCR text from a given image receives the same timestamp/duration, as opposed to each word having a timestamp/duration as in the speech recognition case.

In one embodiment, timestamps, a word comparison algorithm, and probabilistic thresholds can be used to determine whether an optically recognized word should replace a speech recognized word or vice versa. A correctness threshold can be used to determine whether a recognized word is a candidate for being replaced. As an example, if the correctness threshold is set at 70%, then words having an assigned probability of correctness lower than 70% can potentially be replaced. A replacement threshold can be used to determine whether a recognized word is a candidate for replacing words for which the correctness threshold is not met. If the replacement threshold is set at 80%, then words having a probability of correctness of 80% or higher can potentially replace words with a probability of correctness lower than the correctness threshold. In addition, a comparison engine can be used to determine whether a given word and its potential replacement are similar enough to warrant replacement. The comparison engine can utilize timestamps, word length, number of syllables, first letters, last letters, phonemes, etc. to compare two words and determine the likelihood that a replacement should be made.

As an example, the correctness threshold can be set at 70% and the replacement threshold at 80%. The speech recognition engine may detect, with a 45% probability of correctness, that the word ‘pajama’ was spoken during a video presentation at timestamp 00:15:07.23. Because 45% is lower than the 70% correctness threshold, ‘pajama’ is a word that can be replaced if an acceptable replacement word is found. The OCR engine may detect, with a 94% probability of correctness, that the word ‘gamma’ appeared on a slide during the presentation from timestamp 00:14:48.02 until timestamp 00:15:18.43. Because 94% is higher than 80%, the replacement threshold is met and ‘gamma’ can be used to replace speech recognized words if the other conditions are satisfied. Further, the comparison engine can determine, based on timestamps, last letters, and last phonemes, that the words ‘pajama’ and ‘gamma’ are similar enough to warrant replacement if the probabilistic thresholds are met. Thus, with all three conditions satisfied, the optically recognized ‘gamma’ can replace the speech recognized ‘pajama’ in the machine caption.

The threshold probabilities used in the prior example are merely exemplary for purposes of demonstration. Other values can be used, depending upon the embodiment. In an alternative embodiment, only a comparison engine is used to determine whether word replacement should occur. In another alternative embodiment, only homonym word replacement is implemented. In another alternative embodiment, text produced from the OCR process can be used as input to the speech recognition system, allowing the system to (1) add any OCR words to the speech recognition system's vocabulary, if they are not already present, and (2) dynamically create/modify its language model in order to reflect the fact that the OCR words should be given more consideration by the speech recognition system. In another embodiment, text produced from the OCR process can be used as input to perform topic or theme detection, which in turn allows the speech recognition system to give more consideration to the OCR words themselves, but also other words that belong to the identified topic or theme (e.g. if a “dog” topic is identified, the speech recognition system might choose “Beagle” over “Eagle”, even though neither word was part of the OCR text results). In another embodiment, speech recognition and OCR processes are run independently, with the speech recognition output configured to produce a word lattice. A word lattice is a word graph of all possible candidate words recognized during the decoding of an utterance, including other attributes such as their timestamps and likelihood scores. In this embodiment, word lattice candidate words are selected or given precedence if they match the corresponding (in time) OCR output words.

In one embodiment, the OCR engine is enhanced with contextualization functionality. Contextualization allows the OCR engine to recognize what it is seeing and distinguish important words from unimportant words. For instance, the OCR engine can be trained to recognize common applications and formats such as Microsoft Word, Microsoft PowerPoint, desktops, etc., and disregard irrelevant words located therein. For example, if a Microsoft Word document is captured by the OCR engine, the OCR engine can automatically know that the words ‘file,’ ‘edit,’ ‘view,’ etc. in the upper left hand portion of the document have a low probability of relevance because they are part of the application. Similarly, the OCR engine can be trained to recognize that ‘My Documents,’ ‘My Computer,’ and ‘Recycle Bin’ are phrases commonly found on a desktop and hence are likely irrelevant. In one embodiment, the contextualization functionality can be disabled by the operator. Disablement may be appropriate in instances of software training, such as a video tutorial for training users in Microsoft Word. OCR contextualization can be used to increase OCR accuracy. For example, OCR engines are typically sensitive to character sizes. Accuracy can degrade if characters are too small or vary widely within the same image. While some OCR engines attempt to handle this situation by automatically enhancing the image resolution, perhaps even on a regional basis, this can be error prone since this processing is based solely on analysis of the image itself. OCR contextualization can be used to overcome some of these problems by leveraging domain knowledge about the image's context (e.g. what a typical Microsoft Outlook window looks like). Once this context is identified, information can be generated to assist the OCR engine (e.g. define image regions and their approximate text sizes) itself or to create better OCR input images via image segmentation and enhancement. Another way OCR contextualization can improve OCR accuracy is to assist in determining whether the desired text to be recognized is computer generated text, handwritten text, or in-scene (photograph) text. Knowing the type of text can be very important, as alternate OCR engines might be executed or at least tuned for optimal performance. For example, most OCR engines have a difficult time with in-scene text, as it is common for this text to have some degree of rotation, which must be rectified either by the OCR engine itself or by external pre-processing of the image.

In an operation 120, the automatic captioning engine can generate alternate words. Alternate words are words which can be presented to an operator during caption editing to replace recognized (suggested) words. They can be generated by utilizing the probabilities of correctness from both the speech recognition and OCR engines. In one embodiment, an alternate word list can appear as an operator begins to type and words not matching the typed letters can be eliminated from the list. For instance, if an operator types the letter ‘s,’ only alternate word candidates beginning with the letter ‘s’ appear on the alternate word list. If the operator then types an ‘i,’ only alternate word candidates beginning with ‘s’ remain on the alternate word list, and so on.

In one embodiment, alternate words are generated directly by the speech recognition engine. In an alternative embodiment, the alternate words can be replaced by or supplemented with optically recognized words. Alternate words can be generated by utilizing a speech recognition engine's word lattice, N-best list, or similar output option. As mentioned above, a word lattice is a word graph of all possible candidate words recognized during the decoding of an utterance, including other attributes such as their timestamps and likelihood scores. An N-best list is a list of the N most probable word sequences for a given utterance. Similarly, it is possible for an OCR engine to generate alternate character, word, or phrase choices.

In an operation 130, the machine generated caption can be automatically formatted to save valuable time during caption editing. Formatting, which can refer to caption segmentation, labeling, caption placement, word spacing, sentence formation, punctuation, capitalization, speaker identification, emotion, etc., is very important in creating a readable caption, especially in the context of closed captioning where readers do not have much time to interpret captions. Pauses between words, basic grammatical rules, basic punctuation rules, changes in accompanying background, changes in tone, and changes in speaker can all be used by the automatic captioning engine to implement automatic formatting. Further, emotions, such as laughter and crying can be detected and included in the caption. Formatting, which can be one phase of a multi-media analysis, is described in more detail with reference to FIG. 3.

In one embodiment, the automatic captioning engine can also create metadata and/or indices that a search tool can use to conduct searches of the multi-media. The search tool can be text-based, such as the Google search engine, or a more specialized multi-media search tool. One advantage of a more specialized multi-media search tool is that it can be designed to fully leverage the captioning engine's metadata, including timestamp information that could be used to play back the media at the appropriate point, or in the case of OCR text, display the appropriate slide.

In an operation 140, the machine generated caption is communicated to a human editor. The machine generated output consists not only of best guess caption words but also a variety of other metadata such as timestamps, word lattices, formatting information, etc. Such metadata is useful within both the caption editor and for use by a multi-media search tool.

FIG. 3 illustrates exemplary operations performed during a multi-media analysis. In one embodiment, data processing operations performed during the multi-media analysis can be incorporated into the automatic captioning engine described with reference to FIG. 2 as part of the formatting algorithm. In alternative embodiments, data processing operations performed during multi-media analysis can be independent of the automatic captioning engine. Multi-media caption formatting can be implemented through the use of a variety of data processing operations, including media analysis and/or language processing operations. Multi-media data is received in an operation 75. In an operation 142, caption text with timestamps can be created. In one embodiment, the caption text and timestamps are created by the speech recognition and OCR engines described with reference to FIG. 2. The caption text and timestamp suggestions can be used to implement language processing in an operation 156. Language processing can include using timestamps to place machine recognized words, phrases, and utterances into a machine generated caption. In one embodiment, language processing includes providing capitalization suggestions based upon pre-stored data about known words that should be capitalized. In another alternative embodiment, language processing can be used to add punctuation to the captions.

In an operation 144, scene changes within the video portion of multi-media can be detected during the multi-media analysis to provide caption segmentation suggestions. Segmentation is utilized in pop-on style captions (as opposed to scrolling captions) such that the captions are broken down into appropriate sentences or phrases for incremental presentation to the consumer. In an operation 146, periods of silence or low sound level within the audio-portion of the multi-media can be detected and used to provide caption segmentation suggestions. Audio analysis can be used to identify a speaker in an operation 148 such that caption segmentation suggestions can be created. In an operation 157, caption segments are created based on the scene changes, periods of silence, and audio speaker identification. In an alternative embodiment, timestamp suggestions, face recognition, acoustic classification, and lip movement analyses can also be utilized to create caption segments. In an alternative embodiment, the caption segmentation process can be assisted by using language processing. For instance, language constraints can ensure that a caption phrase does not end with the word ‘the’ or other inappropriate word.

In an operation 150, face recognition analysis can be implemented to provide caption label suggestions such that a viewer knows which party is speaking. Acoustic classification can also be implemented to provide caption label suggestions in an operation 152. Acoustic classification allows sounds to be categorized into different types, such as speech, music, laughter, applause, etc. In one embodiment, if speech is identified, further processing can be performed in order to determine speaker change points, speaker identification, and/or speaker emotion. The audio speaker identification, face recognition, and acoustic classification algorithms can all be used to create caption labels in an operation 158. The acoustic identification algorithm can also provide caption segmentation suggestions and descriptive label suggestions such as “music playing” or “laughter”.

In an operation 154, lip movement can be detected to determine which person on the screen is currently speaking. This type of detection can be useful for implementing caption placement (operation 159) in the case where captions are overlaid on top of video. For example, if two people are speaking, placing captions near the speaking person helps the consumer understand that the captions pertain to that individual. In an alternative embodiment, caption placement suggestions can also be provided by the audio speaker identification, face recognition, and acoustic classification algorithms described above.

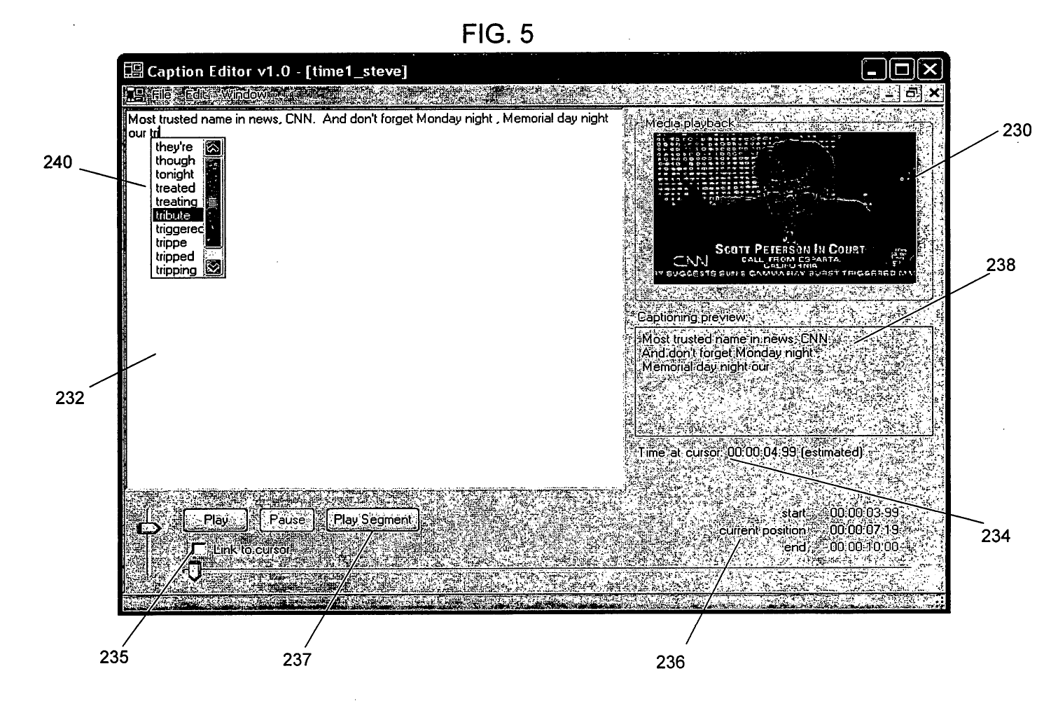

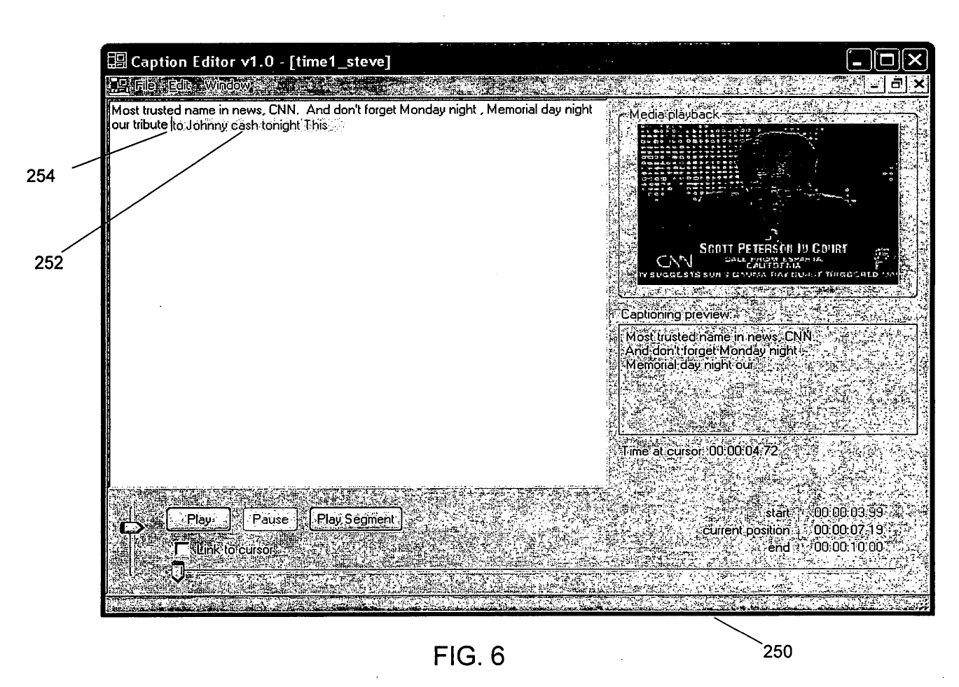

FIG. 4 illustrates exemplary operations performed by the caption editor described with reference to FIG. 1. Additional, fewer, or different operations may be performed depending on the embodiment or implementation. The caption editor can be used by a human operator to make corrections to a machine caption created by the automatic captioning engine described with reference to FIGS. 1 and 2. An operator can access and run the caption editor through an operator interface. An exemplary operator interface is described with reference to FIGS. 5 and 6.

In an operation 160, the caption editor captures a machine generated caption (machine caption) and places it in the operator interface. In one embodiment, the machine caption is placed into the operator interface in its entirety. In an alternative embodiment, smaller chunks or portions of the machine caption are incrementally provided to the operator interface. In an operation 170, an operator accepts and/or corrects word and phrase suggestions from the machine caption.

In an operation 180, the multi-media playback can be adjusted to accommodate operators of varying skills. In one embodiment, the caption editor automatically synchronizes multi-media playback with operator editing. Thus, the operator can always listen to and/or view the portion of the multi-media that corresponds to the location being currently edited by the operator. Synchronization can be implemented by comparing the timestamp of a word being edited to the timestamp representing temporal location in the multi-media. In an alternative embodiment, a synchronization engine plays back the multi-media from a period starting before the timestamp of the word currently being edited. Thus, if the operator begins editing a word with a timestamp of 00:00:27.00, the synchronization engine may begin multi-media playback at timestamp 00:00:25.00 such that the operator hears the entire phrase being edited. Highlighting can also be incorporated into the synchronization engine such that the word currently being presented via multi-media playback is always highlighted. Simultaneous editing and playback can be achieved by knowing where the operator is currently editing by observing a cursor position within the caption editor. The current word being edited may have an actual timestamp if it was a suggestion based on speech recognition or OCR output. Alternatively, if the operator did not accept a suggestion from the automatic captioning engine, but instead typed in the word, the word being edited may have an estimated timestamp. Estimated timestamps can be calculated by interpolating values of neighboring timestamps obtained from the speech recognition or OCR engines. Alternatively, estimated timestamps can be calculated by text-to-speech alignment algorithms. A text-to-speech alignment algorithm typically uses audio analysis or speech analysis/recognition and dynamic programming techniques to associate each word with a playback location within the audio signal.

In one embodiment, timestamps of words or groups of words can be edited in a visual way by the operator. For example, a timeline can be displayed to the user which contains visual indications of where a word or group of words is located on the timeline. Examples of visual indications include the word itself or simply a dot representing the word. Visual indicators may be also be colored or otherwise formatted, in order to allow the operator to differentiate between actual or estimated timestamps. Visual indicators may be manipulated (e.g. dragged) by the operator in order to adjust their position on the timeline and hence their timestamps related to the audio.

Multi-media playback can also be adjusted by manually or automatically adjusting playback duration. Playback duration refers to the length of time that multi-media plays uninterrupted, before a pause to allow the operator to catch up. Inexperienced operators or operators who type slow may need a shorter playback duration than more experienced operators. In one embodiment, the caption editor determines an appropriate playback duration by utilizing timestamps to calculate the average interval of time that an operator is able to stay caught up. If the calculated interval is for example, forty seconds, then the caption editor automatically stops multi-media playback every forty seconds for a short period of time, allowing the operator to catch up. In an alternative embodiment, the operator can manually control playback duration.

Multi-media playback can also be adjusted by adjusting the playback rate of the multi-media. Playback rate refers to the speed at which multi-media is played back for the operator. Playback rate can be increased, decreased, or left unchanged, depending upon the skills and experience of the operator. In one embodiment, the playback rate is continually adjusted throughout the editing process to account for speakers with varying rates of speech. In an alternative embodiment, playback rate can be manually adjusted by the operator.

In an operation 190, the caption editor suggests alternate words to the operator as he/she is editing. Suggestions can be made by having the alternate words automatically appear in the operator interface during editing. The alternate words can be generated by the automatic captioning engine as described with reference to FIG. 2. As an example, if the editor is editing the word ‘heir,’ a list containing the words ‘air,’ ‘err,’ and ‘ere’ can automatically appear as alternates. If the operator selects an alternate word, it can automatically replace the recognized word in the machine caption. In one embodiment, the operator interface includes a touch screen such that an operator can select alternate words by touch. In one embodiment, alternate words are filtered based on one or more characters typed by the operator. In this scenario, if the actual spoken word was ‘architect’, after the operator enters the character ‘a’, only alternate words beginning with ‘a’ are available to the operator for selection.

In an operation 200, alternate word selections are filtered down throughout the rest of the caption. Other corrections made by the operator can filter down to the rest of the caption in an operation 210. For example, if the operator selects the alternate word ‘medicine’ to replace the recognized word ‘Edison’ in the caption, the caption editor can automatically search the rest of the caption for other instances where it may be appropriate to replace the word ‘Edison’ with ‘medicine.’ Similarly, if the caption editor detects that an operator is continually correcting the word ‘cent’ by adding an ‘s’ to obtain the word ‘scent,’ it can automatically filter down the correction to subsequent occurrences of the word ‘cent’ in the machine caption. In one embodiment, words in the caption that are replaced as a result of the filter down process can be placed on the list of alternate word choices suggested to the operator. In one embodiment, an operator setting is available which allows the operator to determine how aggressively the filter down algorithms are executed. In an alternative embodiment, filter down aggressiveness is determined by a logical algorithm based on operator set preferences. For example, it may be that filter down is only performed if two occurrences of the same correction have been made. In one embodiment, corrections made by the operator can also be used to generally improve the next several word suggestions past the correction point. When an operator makes a correction, that information, along with a pre-set number of preceding corrections, can be used to re-calculate word sequence probabilities and therefore produce better word suggestions for the next few (usually 3 or 4) words.

In an operation 220, timestamps are recalculated to ensure that text-to-speech alignment is accurate. In one embodiment, timestamps are continually realigned throughout the editing process. It may be necessary to create new timestamps for inserted words, associate timestamps from deleted words with inserted words, and/or delete timestamps for deleted words to keep the caption searchable and synchronous with the multi-media from which it originated. In an alternative embodiment, timestamp realignment can occur one time when editing is complete. In another alternative embodiment, any caption suggestions that are accepted by the operator are considered to have valid timestamps, and any other words in the caption are assigned estimated timestamps using neighboring valid timestamps and interpolation. Operators can also be given a mechanism to manually specify word timestamps when they detect a timing problem (e.g. the synchronized multi-media playback no longer tracks well with the current editing position).

The edited caption can be sent to a publishing engine for distribution to the appropriate entity. In an alternative embodiment, the publishing engine can be incorporated into the caption editor such that the edited caption is published immediately after editing is complete. In another alternative embodiment, publishing can be implemented in real time as corrections are being made by the operator.

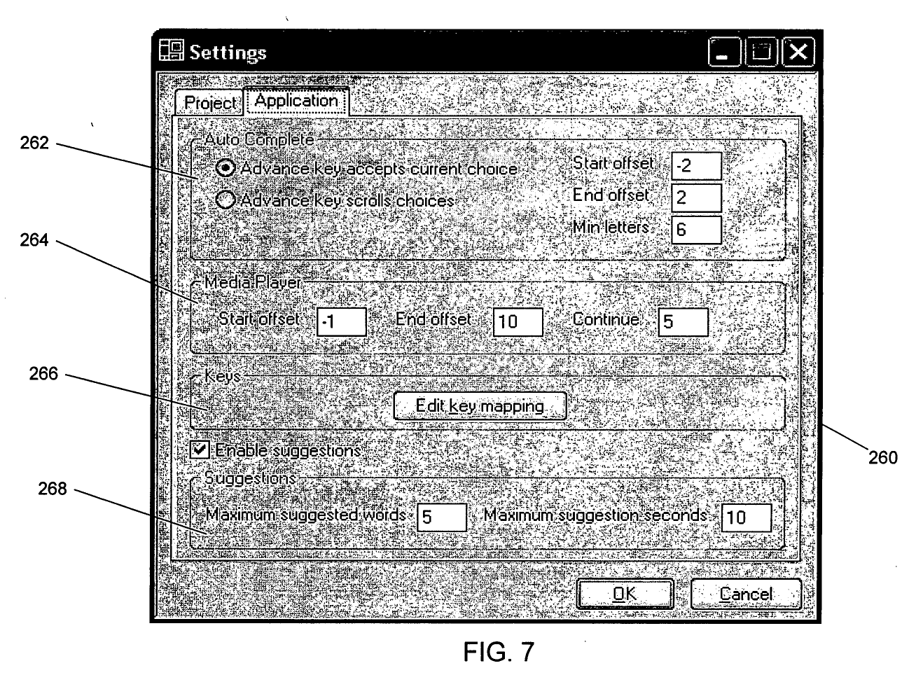

FIG. 5 illustrates an exemplary operator interface containing an alternate word list 240. The multi-media playback window 230 displays the multi-media to the operator as the operator is editing the machine caption. The caption window 232 displays the machine caption (or a portion thereof) obtained from the automatic captioning engine described with reference to FIG. 2. The caption window 232 also displays the edited caption. Time at cursor 234 is the timestamp for the portion of the caption over which the operator has a cursor placed. Link to cursor 235 initiates the multi-media playback operation described with reference to FIG. 4. Play segment 237 allows for user initiated playback of the current media segment. Segmented playback is described in more detail with reference to FIG. 7. Current position 236 is the current temporal position of the multi-media being played in the multi-media playback window 230. A captioning preview window 238 is provided to allow operators to verify proper word playback timing. In an alternative embodiment, words in the captioning preview window are highlighted such that the operator can verify proper word playback timing. In one embodiment, the operator interface includes a touch screen such that operators can edit by touch.

The alternate word feature in FIG. 5 is shown by an alternate word list 240. In the embodiment illustrated, the operator has entered the characters ‘tri’ in the caption window 232 and based on those letters, the alternate word feature has highlighted the word ‘tribute’ such that the user can place ‘tribute’ into the caption by pressing a hot key. Choices within the alternate word list 240 can initially be ordered in decreasing likelihood by using likelihood probabilities such that the number of keystrokes the operator will need to invoke in order to select the correct choice is minimized.

FIG. 6 illustrates an incremental word suggestion feature of the caption editor described with reference to FIG. 4. A phrase suggestion 252 to the right of the cursor 254 has been presented to the operator. To quickly accept or delete the phrase suggestion 252, the operator interface 250 allows hot keys to be defined by the operator. Therefore, if indeed the next 5 spoken words are ‘to Johnny cash tonight This’, then the operator need only make five key presses to accept them. In an alternative embodiment, the entire phrase can be accepted with a single key stroke.

FIG. 7 illustrates an exemplary settings dialog 260 for a caption editor. The auto complete dialog 262 allows an operator to control the alternate word feature of the caption editor. The start offset and end offset values (specified in seconds) within the auto complete dialog 262 provide control over the number of entries that appear in an alternate word list. Based on the settings illustrated, only alternate word candidates from a period of 2 seconds before the current cursor position to a period of 2 seconds after the current cursor position are placed in the list. Alternate word candidates far (in time) from the current cursor position are less likely to be the correct word. The Min letters value in the auto complete dialog 262 specifies the minimum number of letters an alternate word must contain in order to qualify for population within the alternate word list. The purpose of Min letters is to keep short words out of the suggestion list because it may be faster to just type in the word than scroll through the list to find the correct word. The auto complete dialog 262 also allows the operator to decide whether pressing a user-set ‘advance key’ will accept a highlighted word or scroll through word choices.

The media player dialog 264 allows a user to manually adjust playback duration settings in the caption editor. Start offset (specified in seconds) sets the amount of media playback that will occur before the starting cursor position such that the media is placed into context for the operator. End offset (specified in seconds) sets the amount of media playback that occurs before playback is stopped in order to let the operator catch up. Together, the start offset and end offset define a media playback segment or media playback time window. Continue (specified in seconds) sets the offset position such that, when reached by the editing operator, the caption editor should automatically establish a new media playback segment (using current cursor position and start/end offset values) and automatically initiate playback of that new segment. With the settings illustrated in FIG. 7, media playback can commence at the point in the multi-media corresponding to 1 second prior to the current cursor position. Media playback continues for 11 seconds, up until the point in the multi-media that corresponds to 10 seconds past the cursor position (as it was at the commencement of the media playback duration). When the operator reaches an editing point that corresponds to 5 seconds (the continue value) beyond the start time of the current segment, caption editor recalculates actual media segment start and end times based on the current editing position and initiates a playback of the new segment. If the operator hasn't reached the continue position prior to the end playback position being reached, then the caption editor stops media playback until the operator reaches the continue position, at which time caption editor recalculates new media segment values and initiates playback of the new segment. In an alternative embodiment, an operator can, at any point in time, manually initiate (via hot key, button, etc.) media segment playback that begins at or before the current editing (cursor) position. Manually initiated playback can be implemented with or without duration control. In another alternative embodiment, playback can automatically recommence after a pre-set pause period. In yet another alternative embodiment, playback duration can be controlled automatically by the caption editor based on operator proficiency.

The keys dialog 266 allows an operator to set keyboard shortcuts, hot keys, and the operations performed by various keystrokes. The suggestions dialog 268 allows an operator to control the amount of suggestions presented at a time. The word suggestions can be received by the caption editor from the automatic captioning engine described with reference to FIG. 2. The maximum suggested words setting allows the operator to determine how many words are presented. The maximum suggestion seconds setting allows the operator to set how far forward in time the caption editor goes to find the maximum suggested number of words. This setting essentially disables word suggestions in places of the multi-media where no words were confidently recognized by the automatic captioning engine. Based on the settings illustrated, the caption editor only presents the operator with recognized suggestions that are within 10 seconds of the current cursor position. If less than 5 words are recognized in that 10 second interval, then the operator is presented with a suggestion of anywhere from 0-4 words. Operators can also manually disable the suggestions feature.

FIG. 8 illustrates exemplary operations performed by the multi-media indexing engine described with reference to FIG. 1. Additional, fewer, or different operations may be performed depending on the embodiment of implementation. In an operation 280, timestamps are created for caption data. Timestamps of speech and optically recognized words can be the same as those initially created by the automatic captioning engine described with reference to FIG. 2. Timestamps can also be created for words inserted during editing by using an interpolation algorithm based on timestamps from recognized words. Timestamps can also be created by text-to-speech alignment algorithms. Timestamps can also be manually created and/or adjusted by an operator during caption editing.

In an operation 290, caption data is indexed such that word searches can be easily conducted. Besides word searches, phrase searches, searches for a word or phrase located within so many characters of another word, searches for words or phrases not located close to certain other words, etc. can also be implemented. Indexing also includes using metadata from the multi-media, recognized words, edited words, and/or captions to facilitate multi-media searching. Metadata can be obtained during automatic captioning, during caption editing, from a multi-media analysis, or manually from an operator.

In an operation 300, the searchable multi-media is published to a multi-media search tool. The multi-media search tool can include a multi-media search interface that allows users to view multi-media and conduct efficient searches through it. The multi-media search tool can also be linked to a database or other repository of searchable multi-media such that users can search through large amounts of multi-media with a single search.

As an example, during a video lecture, the word ‘transistor’ can have six timestamps associated with it because it was either mentioned by the professor or appeared as text on a slide six times during the lecture. Using a multi-media search interface, an individual searching for the word ‘transistor’ in the lecture can quickly scan the six places in the lecture where the word occurred to find what he/she is looking for. Further, because all of the searchable lectures can be linked together, the user can use the multi-media search interface to search for every instance of the word ‘transistor’ occurring throughout an entire semester of video lectures. In one embodiment, in addition to viewing and searching, users can use the multi-media search tool to view and access multi-media captions in the form of closed captions.

In one embodiment, any or all of the exemplary components, including the automatic captioning engine, caption editor, multi-media indexing engine, caption publication engine, and search tool, can be included in a portable device. The portable device can also act as a multi-media capture and storage device. In an alternative embodiment, exemplary components can be embodied as distributable software. In another alternative embodiment, exemplary components can be independently placed. For instance, an automatic captioning engine can be centrally located with the caption editor and accompanying human operator outsourced at various locations.

It should be understood that the above described embodiments are illustrative only, and that modifications thereof may occur to those skilled in the art. The invention is not limited to a particular embodiment, but extends to various modifications, combinations, and permutations that nevertheless fall within the scope and spirit of the appended claims.

What is claimed is:

1. A method for creating captions of multi-media content, the method comprising:
performing an audio analysis operation on an audio signal to produce speech recognition data for each detected utterance, wherein the speech recognition data comprises a plurality of best hypothesis words and corresponding timing information;
displaying the speech recognition data using an operator interface as spoken word suggestions for review by an operator;
enabling the operator to edit the spoken word suggestions within the operator interface, wherein the enabling comprises estimating an appropriate audio portion to be played to the operator at a current moment, based on an indication obtained from the operator interface as to where the operator is currently editing.

2. The method of claim 1, further comprising enabling the operator to accept unedited spoken word suggestions within the operator interface.

3. The method of claim 1, wherein the indication obtained from the operator interface is a cursor position.

4. The method of claim 1, wherein the speech recognition data comprises a word lattice.

5. The method of claim 1, wherein the speech recognition data includes alternate word choices.

6. The method of claim 5, further comprising:
displaying within the operator interface the alternate word choices; and
enabling the operator to select one of the alternate word choices from the operator interface, thereby replacing an original word suggestion.

7. The method of claim 6, wherein the alternate word choices are displayed within the operator interface in response to an operator indication.

8. The method of claim 6, wherein the spoken word suggestions for yet-to-be-edited words are re-ranked based on one or more operator-based corrections.

9. The method of claim 6, wherein the spoken word suggestions for yet-to-be-edited words are re-calculated based on one or more operator-based corrections.

10. The method of claim 6, wherein the operator selection of alternate word choices comprises displaying the alternate word choices in response to the operator typing one or more characters of the correct word, thereby enabling the operator to choose from better suggestions that start only with the one or more typed characters.

11. The method of claim 1, further comprising performing a filter down operation in which information about an operator-based correction is propagated to the remaining yet-to-be-edited suggestions, thereby minimizing occurrences of similar non-correct suggestions.

12. The method of claim 1, further comprising performing a text-to-speech aligner operation after the operator has completed word editing.

13. The method of claim 1, further comprising enabling the operator to review the accuracy of word timing data by providing a visual indication of the data during audio playback.

14. The method of claim 13, wherein the visual indication comprises word highlighting.

15. The method of claim 1, further comprising enabling the operator to directly input updated timestamp data for a particular word or phrase.

16. The method of claim 15, further comprising performing a timestamp recalculation operation wherein the operator input timestamp data is used to improve timestamp estimates of neighboring words.

17. The method of claim 1, further comprising enabling the operator to indicate that a particular word or phrase is correctly timestamped for a current audio playback position.

18. The method of claim 17, further comprising performing a timestamp recalculation operation wherein the operator indication is used to improve timestamp estimates of neighboring words.

19. The method of claim 1, further comprising:
displaying within the operator interface a timeline, wherein the timeline includes a visual indicator of a word timestamp on the timeline; and
enabling the operator to manipulate the visual indicator such that the word timestamp is adjusted.

20. The method of claim 1, further comprising automatically adjusting a playback start time and a playback duration based on an operator's current editing position and an operator specified setting.

21. The method of claim 20, wherein the operator's current editing position is determined from a cursor position.

22. A caption created by the method of claim 1.

23. The method of claim 1, further comprising adjusting a playback duration by automatically detecting an average editing pace of the operator.

24. The method of claim 1, further comprising adjusting a playback start time by automatically detecting an average editing pace of the operator.

25. The method of claim 1, further comprising adjusting playback rate based on an operator-specified setting.

26. The method of claim 1, further comprising adjusting playback rate by automatically detecting an average editing pace of the operator.

27. The method of claim 1, further comprising, after at least one operator edit, but before the final operator edit, performing text-to-speech aligner operations in a repetitive fashion to maintain accurate playback timing information for a playback controller module which provides improved playback assistance to the operator.

28. The method of claim 1, further comprising implementing a data processing operation, wherein the data processing operation comprises:
formatting the captions;
generating caption labels;
segmenting the captions; and
determining an appropriate location for the captions.

29. The method of claim 28, wherein the data processing operation is implemented via a scene break detection operation.

30. The method of claim 28, wherein the data processing operation is implemented via a silence detection operation.

31. The method of claim 28, wherein the data processing operation is implemented via a speaker recognition operation.

32. The method of claim 28, wherein the data processing operation is implemented via a face recognition operation.

33. The method of claim 28, wherein the data processing operation is implemented via an acoustic classification operation.

34. The method of claim 28, wherein the data processing operation is implemented via a lip movement detection operation.

35. The method of claim 28, wherein the data processing operation is implemented via a word capitalization operation.

36. The method of claim 28, wherein the data processing operation is implemented via a punctuation operation.

37. The method of claim 28, further comprising sending processed data to a caption editor such that a human operator is able to edit the processed data.

38. A system for creating captions of multi-media content, the system comprising:
means for performing an audio analysis operation on an audio signal to produce speech recognition data for each detected utterance, wherein the speech recognition data comprises a plurality of best hypothesis words and corresponding timing information;
means for displaying the speech recognition data using an operator interface as spoken word suggestions for review by an operator;
means for enabling the operator to edit the spoken word suggestions within the operator interface, wherein the enabling comprises estimating an appropriate audio portion to be played to the operator at a current moment, based on an indication obtained from the operator interface as to where the operator is currently editing.

39. The system of claim 38, wherein the speech recognition data comprises a word lattice.

40. The system of claim 38, further comprising means for enabling the operator to accept unedited spoken word suggestions within the operator interface.

41. The system of claim 38, wherein the indication obtained from the operator interface is a cursor position.

42. The system of claim 38, wherein the speech recognition data includes alternate word choices.

43. A computer program product for creating captions of multi-media content, the computer program product comprising:
computer code to perform an audio analysis operation on an audio signal to produce speech recognition data for each detected utterance, wherein the speech recognition data comprises a plurality of best hypothesis words and corresponding timing information;
computer code to display the speech recognition data using an operator interface as spoken word suggestions for review by an operator;
computer code to enable the operator to edit the spoken word suggestions within the operator interface, wherein the enabling comprises estimating an appropriate audio portion to be played to the operator at a current moment, based on an indication obtained from the operator interface as to where the operator is currently editing.

44. The computer program product of claim 43, wherein the speech recognition data comprises a word lattice.

45. The computer program product of claim 43, further comprising computer code to enable the operator to accept unedited spoken word suggestions within the operator interface.

46. The computer program product of claim 43, wherein the indicator obtained from the operator interface is a cursor position.

47. A method for facilitating captioning, the method comprising:
performing an automatic captioning function on multi-media content, wherein the automatic captioning function creates a machine caption by utilizing speech recognition and optical character recognition on the multi-media content;
providing a caption editor, wherein the caption editor:
includes an operator interface for facilitating an edit of the machine caption by a human operator; and
distributes the edit throughout the machine caption; and
indexing a recognized word to create a searchable caption for use in a multi-media search tool, wherein the multi-media search tool includes a search interface that allows a user to locate relevant content within the multi-media content.

48. A method for creating machine generated captions of multi-media, the method comprising:
performing an optical character recognition operation on a multi-media image, wherein the optical character recognition operation produces text correlated to an audio portion of the multi-media; and
utilizing the correlated text to perform an enhanced audio analysis operation on the multi-media.

49. The method of claim 48, wherein the correlated text is utilized during the audio analysis operation.

50. The method of claim 48, wherein the correlated text is utilized after the audio analysis operation.

51. The method of claim 48, further comprising indexing a caption to create a searchable caption for use in a multi-media search tool, wherein the multi-media search tool includes a search interface such that a user is able to locate a relevant portion of multi-media content.

52. The method of claim 48, wherein the enhanced audio analysis operation creates word suggestions for use within a caption editor, wherein the caption editor includes an operator interface for facilitating an edit by a human operator.

53. A method for creating machine generated captions of multi-media, the method comprising:
performing an audio analysis operation on an audio portion of multi-media to produce speech recognition data for each detected utterance, wherein the speech recognition data is correlated to an image based portion of the multi-media;
utilizing the correlated speech recognition data to perform an enhanced optical character recognition operation on the image based portion of the multi-media.

54. The method of claim 53, wherein the correlated speech recognition data is utilized during the optical character recognition operation.

55. The method of claim 53, wherein the correlated speech recognition data is utilized after the optical character recognition operation.
